(19) United States
(12) Patent Application Publication
(10) Pub. No.: US 2012/0021152 A1
(43) Pub. Date: Jan. 26, 2012

(54) POLYMER COMPOSITIONS CONTAINING NANOPARTICULATE IR ABSORBERS

(75) Inventors: Alban Glaser, Mannheim (DE); Johannes Loebel, Mannheim (DE)

(73) Assignee: BASF SE, Ludwigshafen (DE)

(21) Appl. No.: 13/147,083

(22) PCT Filed: Feb. 8, 2010
(86) PCT No.: PCT/EP2010/051457

§ 371 Date: Jul. 29, 2011

(30) Foreign Application Priority Data
Feb. 12, 2009 (EP) 09152703.6

(51) Int. Cl. B32B 1/02; B32B 27/36; B32B 27/32; B32B 27/34; F21V 9/04; B32B 27/40

(52) U.S. Cl. 428/35.5; 252/587; 428/500; 428/474.4; 428/423.1; 428/412; 428/473.5; 428/523; 428/220

(57) ABSTRACT

The invention relates to processes for preparing polymer compositions by means of preparations of nanoparticulate IR absorbers, and also to polymer compositions thus prepared. Uses of these polymer compositions, as for example in heat management or in agriculture, more particularly as greenhouse films, are likewise provided by the invention. Additionally provided by the invention are shaped articles, more particularly films, comprising such polymer compositions.

The present invention relates to processes for preparing polymer compositions by means of preparations of nanoparticulate IR absorbers, and also to polymer compositions thus prepared. Uses of these polymer compositions, as for example in heat management or in agriculture, more particularly as greenhouse films, are likewise provided by the invention. Additionally provided by the invention are shaped articles, more particularly films, comprising such polymer compositions.

Further embodiments of the present invention can be found in the claims, description, and examples. It is self-evident that the features stated above and those still to be elucidated below in respect of the subject matter of the invention can be used not only in the combination indicated specifically in each case, but also in other combinations, without departing from the scope of the invention. Preferred and very preferred, respectively, are those embodiments of the present invention in which all of the features have the preferred and very preferred definitions.

EP 1 554 924 A1 describes materials for screening from thermal radiation in the sector of agriculture or of horticulture. The materials include a ply consisting of a resin substrate and a filler comprising fine particles in dispersion in the resin. The fine particles are, for example, lanthanum hexaboride or antimony-doped tin oxide.

EP 1 865 027 A1 describes polycarbonate compositions comprising fine metal boride particles. The shaped articles described in EP 1 865 027 A1, consisting of such polycarbonate compositions, can be used as materials for windows and roofs or as films in agriculture.

GB 2 014 513 A describes transparent thermoplastic laminates which can be used as materials for greenhouses. The laminates comprise at least two layers, the layer right at the bottom having a high UV resistance, and the other layers being opaque to IR radiation.

Allingham, in U.S. Pat. No. 4,895,904, describes sheets or films of polymers and the use thereof in greenhouses. Such sheets or films comprise finely divided components which reflect or absorb in the NIR region. These sheets or films are transparent for a fraction of at least 75% of the radiation that is relevant for photosynthesis. Finely divided components used are oxides or metals. Furthermore, there are UV stabilizers in the sheets or films.

The excessive accommodation of thermal radiation, particularly the thermal radiation of sunlight, by the surface, for example, of buildings, vehicles, warehouses or greenhouses often leads to a significant increase in the internal temperatures, particularly in locations with high insolation. In the case of greenhouses, this increase in heat exposure has adverse consequences for the yield of the plants cultured in the greenhouse.

Through the screening of the thermal radiation, however, the intention frequently is not to shut out other regions of the solar spectrum at the same time. In the case of the screening of thermal radiation by greenhouse films, in particular, in addition to effective screening of the thermal radiation, the aim is for a high transparency in the visible spectral range, particularly in the range of the visible spectrum that is relevant for the processes of photosynthesis in plants. In these applications especially, therefore, only a low level of hazing of the materials as a result of the thermal protection is accepted, since even a slightly increased transparency leads in general to a significant increase in the yield.

It was an object of the present invention, therefore, to provide a screen against thermal radiation on exposure to light, more particularly to solar radiation on the surface of, for example, greenhouses, and to ensure a high transparency for visible light in conjunction with effective screening of the thermal radiation.

These objects and others have been achieved, as described below, by processes for preparing a polymer composition, comprising the following steps:
a. providing a polymer melt,
b. providing a preparation comprising a liquid carrier medium with nanoparticulate IR absorbers dispersed therein,
c. mixing the polymer melt (a.) with the preparation (b.),
d. processing the mixture (c.).

Nanoparticulate IR absorbers for the purposes of the present specification are particles having a mass-average particle diameter of generally not more than 200 nm, preferably of not more than 100 nm. One preferred particle size range is 4 to 100 nm, more particularly 5 to 90 nm. Particles of this kind are notable in general for a high level of uniformity in terms of their size, size distribution, and morphology. The particle size may be determined in accordance for example with the UPA (Ultrafine Particle Analyzer) method, as for example by the laser light back-scattering method.

In the IR range (about 700 to 12 000 nm), preferably in the NIR range from 700 to 1500 nm, more preferably in the range from 900 to 1200, the nanoparticulate IR absorbers exhibit strong absorption. In the visible spectral range from about 400 nm to 760 nm, the nanoparticulate IR absorbers exhibit only weak absorption.

Generally speaking, a material is designated as being transparent if objects lying behind it can be perceived with relative clarity—window glass, for example. Transparency in the context of the present invention denotes optical transparency substantially without scattering of the light by the transparent material in the visible spectral range.

For the measurement of the haze it is possible to use a haze meter, an example being that from Bykgardner. The instrument consists of a tube which is placed in front of an Ulbricht sphere. The haze can be measured in accordance with ASTM D1003-7, as mentioned in EP 1 529 632 A1, for example.

The temperature and pressure conditions under which the preparation process of the invention is carried out are generally dependent on the polymers and carrier media used, and may therefore vary over a wide range. In general the providing of a polymer melt (a.) is carried out at temperatures from 100 to 300° C., preferably from 100 to 250° C. In general the providing of a preparation (b.) is carried out at temperatures from 0 to 150° C., preferably from 10 to 120° C. The mixing of the polymer melt with the preparation in step c. takes place in general at temperatures from 100 to 300° C., preferably from 100 to 250° C. The mixing in step d. is carried out generally at temperatures from 100 to 300° C., preferably from 100 to 250° C. All steps in the process of the invention can be carried out under atmospheric pressure (1 atm.), but also at a superatmospheric pressure of up to 100 bar or under a slight subatmospheric pressure.

It will be appreciated that, for the providing of the polymer melt (a.), one or more polymers can be used, in the form of polymer mixtures or blends, for example.

In one preferred embodiment of the process of the invention, thermoplastic polymers are selected as polymers for providing the polymer melt (a.).

Thermoplastic polymers contemplated include oligomers, polymers, ionomers, dendrimers, copolymers, such as block copolymers, graft copolymers, star-shaped block copolymers, random block copolymer or mixtures of these. Generally speaking, the thermoplastic polymers have mass-average molecular weights Mw of 3000 to 1 000 000 g/mol. Preferably, Mw is 10 000 to 100 000 g/mol, very preferably 20 000 to 50 000 g/mol, more particularly from 25 000 to 35 000 g/mol.

Thermoplastic polymers include primarily polyolefins, more particularly polypropylenes and polyethylenes, polyolefincopolymers, more particularly ethyl-vinyl acetate copolymers, polytetrafluoroethylenes, ethylene-tetrafluoroethylene copolymers, polyvinylidene fluorides (PVDF), polyvinyl chlorides (PVC), polyvinylidene chlorides, polyvinyl alcohols, polyvinyl esters, polyvinylalkanols, polyvinylketals, polyamides, polyimides, polycarbonates, polycarbonate blends, polyesters, polyester blend, poly(meth)acrylates, poly(meth)acrylate-styrene copolymer blends, poly(meth)acrylate-polyvinylidene difluoride blends, polyurethanes, polystyrenes, styrene copolymers, polyethers, polyetherketones, polysulfones, and mixtures of these polymers. It is preferred to use polyethylenes, PVC or PVDF.

Polymer melts can be provided by any desired methods known to the skilled person, such as, for example, with the melting of polymers. The polymers in this case may be present, prior to melting, in the form of powders and pellets. The polymers are preferably in the form of pellets. Melting takes place preferably in an extruder or calender.

The process of the invention for preparing a polymer composition comprises in step (b.) the providing of a liquid carrier medium with nanoparticulate IR absorbers dispersed therein. This means that the carrier medium is liquid under the pressure and temperature conditions employed in each case in steps (b.) and (c.). For the purposes of the present invention, a liquid carrier medium is a carrier medium having rheological properties which range from runny through pasty/creamy to gellike. “Fluid compounds” generally have a higher viscosity than a liquid, but are still not self-supporting—in other words, without a shape-stabilizing covering, they do not retain a shape imparted to them. In the context of the present invention, the term “liquid carrier medium” is also intended to encompass fluid components. The viscosity of such preparations is situated for example within a range from about 1 to 60 000 mPas.

An advantage of the use of liquid carrier media with dispersed nanoparticulate IR absorbers over the use of nanoparticulate IR absorbers in the solid state, as a powder, for example, is that in general a much more homogeneous distribution of the nanoparticulate IR absorbers in the polymer composition is achievable, without sizeable agglomerates occurring. Sizeable agglomerates, indeed, lead in general to an unwanted, increased scattering of visible light, whereas a fine, homogeneous distribution of the nanoparticulate IR absorbers leads to improved absorption of IR radiation.

Examples of suitable carrier media include many organic solvents which are liquid at room temperature and preferably do not react with oxygen. These solvents preferably have an approximately neutral pH.

Examples of possible carrier media in this context include the following:
esters of alkyl- and arylcarboxylic acids,
hydrated esters of arylcarboxylic acids with alkanols,
mono- or polyhydric alcohols,
ether alcohols,
polyether polyols,
ethers,
saturated acyclic and cyclic hydrocarbons,
mineral oils,
mineral oil derivatives,
silicone oils,
aprotic polar solvents
   or mixtures of these carrier media. As carrier media here it is preferred to use ethylene glycol, glycerol, 1,3-propanediol, 1,4-butanediol, ethylene glycol monomethyl ether, ethylene glycol dimethyl ether, ethylene glycol diethyl ether, acyclic or cyclic ethers, polyether polyols, low-boiling (boiling point less than 200° C.) alcohols, more particularly 1-butanol, 2-butanol, or hydrocarbons with a boiling point of less than 200° C., or mixtures of the stated preferred carrier media.

Additionally contemplated as possible carrier media are waxes. As carrier media it is possible with preference to use polyolefin waxes and polyolefin comonomer waxes, more particularly ethylene homopolymer waxes, montane waxes, oxidized and micronized PE waxes, metallocene PE waxes, and ethylene copolymer waxes, examples being products from the Luwax® range from BASF SE.

Carrier media are generally available commercially.

In one preferred embodiment of the process of the invention, the carrier medium is liquid under atmospheric pressure in a temperature range from 50 to 120° C., preferably in a temperature range from 90 to 110° C. The carrier medium in this case is more particularly a PE wax.

In accordance with the invention, the nanoparticulate IR absorbers are in dispersion in the preparation from step (b.). This means that the nanoparticulate IR absorbers are present homogeneously and finely distributed in the carrier medium. Such dispersion is achieved by the nanoscale IR absorbers forming substantially no aggregates or particles that are larger than 500 nm. Preferably there are no aggregates or particles larger than 300 nm present, very preferably no aggregates or particles larger than 200 nm. More particularly, the particles are separate from one another with an average spacing of at least 200 nm. In one embodiment of the composition from step (b.) of the process of the invention, more than 90% of the particles have an average particle size of less than 200 nm. In a further preferred embodiment, more than 95% of the particles have an average particle size of less than 200 nm. In a further embodiment, more than 99% of the particles have an average particle size of less than 200 nm. In another preferred embodiment, less than 10% of the particles, more preferably less than 5% of the particles, have a smaller distance from the closest particle of at least 50 nm, preferably at least 100 nm, more preferably at least 250 nm, and with particular preference at least 500 nm.

These particles may take on any desired form. For example, spherical, rodlet-shaped, plated-shaped particles or particles with irregular form are possible. It is also possible to use nanoscale IR absorbers having bimodal or multimodal particle size distributions.

The distribution of the particles can be ascertained with the aid, for example, of confocal laser scanning microscopy. The method is described in, for example, “Confocal and Two-Photon Microscopy”, edited by Alberto Diaspro; ISBN 0-471-40920-0, Wiley-Liss, a John Wiley & Sons, Inc. Publication, in chapter 2, pages 19-38, and the citations contained therein. Also possible is the determination of the particle sizes (and particle size distributions) by means of electron microscopy methods (TEM).

Examples that may given of nanoparticulate IR absorbers present in dispersion in the carrier medium in the preparation in step (b.), in the context of the process of the invention, are carbon blacks, metal borides or doped tin oxides.

As IR absorbers it is preferred to use nanoparticulate tin oxides, doped with antimony (ATO) or with indium (ITO), or nanoparticulate metal borides (MBₓ with x from 1 to 6), more particularly alkaline earth metal borides or borides of the rare earths. Particularly preferred are nanoparticulate borides of the rare earths. Especially preferred are metal hexaborides with the symbolic formula MB₆, especially M=La, Pr, Nd, Ce, Tb, Dy, Ho, Y, Sm, Eu, Er, Tm, Yb, Lu, Sr, Ca. Preference is likewise given to metal diborides MB₂, more particularly with M=Ti, Zr, Hf, V, Ta, Cr, Mo. Further suitable metal borides are Mo₂B₅, MoB, and W₂B₅. One very excellent IR absorber is nanoparticulate lanthanum hexaboride (LaB₆). It will be appreciated that mixtures of the stated nanoparticulate substances are also suitable as IR absorbers. Nanoparticulate LaB₆ is available commercially or can be prepared in accordance with the methods from WO 2006/134141 or WO2007/107407. Nanoparticulate ITO or ATO is available commercially.

The amount of nanoparticulate IR absorber used may vary over a wide range and is dependent, for example, on the ultimate intended use of the polymer composition. Critical for an effective activity on the part of the IR absorber is generally the presence of sufficient IR absorber in the radiation path, when the thermal radiation passes through the polymer composition, to absorb the thermal radiation.

The amount of nanoparticulate IR absorber in the polymer composition is up to 2% by weight, based on the thermoplastic polymer melt from step a. The amount of IR absorber is preferably 0.001% to 1%, very preferably 0.01 to 0.5%, and more particularly 0.01% to 0.2%, by weight.

The fraction of IR radiation absorbed by the polymer composition is dependent on the particular desired application. For example, the polymer composition absorbs more than 5% of the incident IR radiation. It is preferred for more than 20%, very preferably more than 50%, of the incident IR radiation to be absorbed.

In general, for providing the preparation in (b.) of the process of the invention, the liquid carrier agent and the nanoparticulate IR absorbers are mixed with one another. This mixing may in principle take place with any desired mixing apparatus known to the skilled person, such as stirrers, extruders, and kneaders, for example.

In one preferred embodiment of the process of the invention for preparing the polymer composition, the providing of the composition in step (b.), comprising metal borides, is accomplished by means of in situ plasma synthesis, as described in the still unpublished EP 08167612.4. In this procedure, a starting material for metal borides is provided, this starting material is subjected to a thermal treatment under plasma conditions, the product obtained is subjected to rapid cooling, and the resultant cooled product is introduced into a liquid, giving a suspension which can be employed directly as preparation in step (b.) of the process of the invention. The starting material for metal borides is provided, for example, by synthesis from suitable reactants. The advantage of this method lies in the high purity of the preparations provided. More particularly, in this case, for example, the abraded grinding-medium material that occurs in grinding processes, and that can lead to contamination of the preparation with extraneous substances and, later on, to the hazing of the polymer composition, is avoided.

In another embodiment, the providing of the preparation from step (b.) is accomplished preferably by incorporating at least one metal boride, preferably MB₆, more particularly LaB₆, into the carrier medium with simultaneous comminution, preferably with milling, as also described in WO2007/107407. It will be appreciated that, with this variant, it is possible to use a metal boride which is already present in the form of nanoparticulate particles. The metal boride to be comminuted is used preferably in non-nanoparticulate form. More particularly, the metal borides to be comminuted have initially a size of 500 nm to 50 μm, preferably of 1 to 20 μm.

The comminuting takes place in apparatus suitable for the purpose, preferably in mills such as, for example, ballmills, agitator ballmills, circulation mills (agitator ballmill with pinned-disk grinding system), disk mills, annular chamber mills, double cone mills, triple-roll mills and batch mills (cf. Arno Kwade, “Grinding and Dispersing with Stirred Media Mills: Research and Application”, Braunschweig Technical University, Faculty of Mechanical Engineering; edition: 1, 2007). If desired, the grinding chambers are equipped with cooling means for removing the thermal energy that is introduced in the grinding operation. For wet grinding for producing the preparations of the invention, suitability is possessed, for example, by the Drais Superflow DCP SF 12 ballmill, the ZETA system circulation mill from Netzsch-Feinmahltechnik GmbH or the disk mill from Netzsch Feinmahltechnik GmbH, Selb, Germany.

For the milling it is common to use grinding media comprising aluminum oxide, zirconium oxide or zirconium oxide doped with yttrium. In the context of the process of the invention, when providing the preparation from step (b.), it is preferred to carry out the grinding of the carrier media with the IR absorbers using grinding media made of aluminum oxide. The advantage of such milling is that the abraded material which arises in the case of the zirconium oxide grinding media typically employed, and leads in general to the hazing of the polymer composition, is not produced.

Preferably, therefore, the polymer compositions prepared by means of the process of the invention have only a low zirconium oxide content. There is preferably less than 0.2% by weight of the zirconium oxide present, based on the polymer composition, more preferably less than 0.15% by weight.

In a further preferred embodiment, therefore, the polymer compositions prepared by means of the process of the invention have from 0.001% to 1%, very preferably 0.01% to 0.8%, and more particularly 0.01% to 0.5%, by weight, of a nanoparticulate metal boride, preferably MB₆, more particularly LaB₆, and only a low zirconium oxide content. There is preferably less than 50% by weight of zirconium oxide present, based on the total amount of zirconium oxide and nanoparticulate metal boride, more preferably less than 40% by weight. With great preference in this context, the nanoparticulate metal borides have a mass-average particulate diameter of not more than 200 nm, preferably of not more than 150 nm, more particularly of 70 to 130 nm.

The comminution takes place preferably with addition of the major amount, more particularly at least 80% to 100%, of the carrier medium.

The duration required for comminuting is guided, in a manner known per se, by the desired degree of fineness, or particle size, of the active ingredient particles, and may be determined by the skilled person in routine experiments. Milling times that have been found appropriate are, for example, in the range from 30 minutes to 72 hours, although a longer duration is also conceivable.

Pressure and temperature conditions accompanying comminution are generally not critical—accordingly, for example, atmospheric pressure has proven suitable. Temperatures which have proven suitable are, for example, temperatures in the range from 10° C. to 100° C., with a temperature increase generally leading to a reduction in the milling time.

In order substantially to prevent agglomeration or coalescence of the nanoparticulate IR absorbers and/or in order to ensure effective dispersibility of the particulate phase in the carrier medium, the IR absorbers used may be surface-modified or surface-coated. For example, the particles, on at least part of their surface, have a single-layer or multi-layer coating which comprises at least one compound having ionogenic, ionic and/or nonionic surface-active groups. The compounds with surface-active groups are preferably selected from the salts of strong inorganic acids, such as nitrates and perchlorates, for example, saturated and unsaturated fatty acids, such as palmitic acid, margaric acid, stearic acid, isostearic acid, nonadecanoic acid, lignoceric acid, palmitoleic acid, oleic acid, linoleic acid, linolenic acid, and eleostearic acid, quaternary ammonium compounds, such as tetraalkylammonium hydroxides, e.g., tetramethylammonium hydroxide, silanes, such as alkyltrialkoxysilanes, and mixtures thereof. In one preferred version, the nanoparticulate IR absorbers used in accordance with the invention have no surface modifiers.

The preparation from step (b.) is produced preferably by in situ comminution, especially in situ milling, in the liquid carrier medium in which it is subsequently employed. In this case, especially after the dispersed state has been attained, the carrier medium is no longer removed from the preparation and its fraction is reduced no more than to an extent such that the dispersed state is maintained. Any partial or complete replacement of the carrier medium is accomplished by liquid-liquid reaction, in the course of which the dispersed state is maintained. Preferably, the carrier medium is not replaced anymore after the preparation has been produced. It is, however, possible to add at least one further component compatible with the carrier medium, provided that the dispersed state is maintained during such addition. The addition of one or more further components may take place before, during or after the dispersed preparation has been produced. The preparation obtained by in situ comminution is preferably subjected to further processing immediately following its production.

The solids content of the preparation from step (b.) is preferably at least 1%, more preferably at least 10%, very preferably at least 20%, and more particularly from 20% to 40%, by weight, based on the total weight of the preparation from step (b.).

The amount of nanoparticulate IR absorber in the preparation from step (b.) is preferably at least 1%, more preferably at least 10%, very preferably at least 20%, and more particularly from 20% to 40%, by weight, based on the total weight of the preparation from step (b.).

The amount of metal boride, more particularly MB6, in the preparation from step (b.) is preferably at least 50%, more preferably at least 65%, by weight, based on the total solids content of the preparation.

As already mentioned, in step (b.) it is also possible to employ preparations comprising waxes and nanoparticulate IR absorbers dispersed therein. The incorporation of nanoparticulate IR absorbers into waxes is normally accomplished, as the skilled person is aware, in a mixing apparatus. This incorporation may involve a so-called flush operation, as in unpublished European patent application 08159697.5, for example. In this case the nanoparticulate IR absorbers are frequently in the form of a dispersion in a polar or aqueous solution. Mixing apparatus used may comprise batch kneaders, dispersion kneaders or else extruders with mixing units. The incorporation of the dispersion of the nanoparticulate IR absorbers takes place with particular preference in a batch kneader. The temperature of the kneading composition, the proportion of the nanoparticulate IR absorbers to the wax, the shearing introduced, and the duration of the shearing are all important here. For the incorporation of the dispersions of the nanoparticulate IR absorbers into the wax, it is possible to run a temperature program, beginning at a slightly elevated temperature and then lowering the temperature in order to increase the viscosity of the composition. This improves the dispersion outcome. A preferred procedure is to melt the wax in the kneader and then to add the dispersion of the nanoparticulate IR absorbers, in portions or all at once. The wax, alternatively, may be introduced as a melt into the mixing device. It is preferred to select a temperature of 50 to 150° C. The temperature in the mixing device is more preferably between 70 and 120° C. Transfer of the nanoparticulate IR absorbers into the apolar environment of the wax phase is apparent from the separation of polar or aqueous solvent or water, which, depending on temperature, escapes the kneading composition in the form of liquid drops or else as water vapor.

The phase transition of the nanoparticulate IR absorbers from the polar dispersion into the wax produces a composition suitable for step (b.) of the process of the invention. The solvent can be separated from the composition in a variety of ways. It can be stripped or evaporated from the mixing device, or the preparation can be removed from the mixing device and then dried and optionally ground.

Generally speaking, preparations are comminuted for greater ease of handling and further processing. In this context, the preparation may be granulated, pelletized or pulverized. For use as a liquid composition in step (b.) of the process of the invention, the composition is of course in the melted state.

The mixing of the liquid preparation from step (b.) with the polymer melt from step (a.) is accomplished in mixing apparatus known to the skilled person, examples being monoextruders or coextruders, and calenders. In this context, the providing of the polymer melt in step (a.) may take place either before or simultaneously with the mixing operation in step (c.). The polymer melt is preferably provided immediately before or during mixing. The providing of the liquid composition in step (b.) takes place in general before the mixing in step (c.). The liquid composition provided is preferably added to the polymer melt in one or more steps during the mixing in step (c.).

In one preferred embodiment of the process of the invention, the providing of a polymer melt (a.) and the mixing (c.) of the polymer melt with the preparation (b.) are accomplished as part of an extrusion, injection molding, blow molding or kneading operation.

The preparation of polymer compositions in step (c.) is preferably in accordance with what is called a mass additivization process. Suitable mass additivization processes include, in detail, extrusion, and also coextrusion, injection molding, blow molding or kneading. The liquid compositions from step (b.) here preferably have boiling temperatures and/or flash temperatures above the processing temperature used for preparing the polymer composition. In another preferred embodiment, liquid compositions from step (b.) here preferably have boiling temperatures below and flash temperatures above the processing temperature used for preparing the polymer composition.

Removal, more particularly substantially complete removal, of the carrier medium of the liquid composition from step (b.) following incorporation into a polymer is generally not necessary, and this is an advantage of the process of the invention.

In the context of the process of the invention, after the mixing in step (c.), the polymer compositions are processed in step (d.). Processing here takes place in accordance with the customary steps, known to the skilled person, for the processing of plastics. The polymer compositions may more particularly be further-processed by extrusion, compounding, processing to granules or pellets, processing to shaped articles by extrusion, including coextrusion, injection molding, blow molding or kneading in step (d.). The polymer compositions are preferably processed by extrusion or coextrusion to form films (cf. Saechtling Kunststoff Taschenbuch, 28th edition, Karl Oberbach, 2001).

The invention further provides a polymer composition produced in accordance with the above-described production process of the invention.

In one specific version, the polymer compositions of the invention, and the shaped articles produced from them, comprise or consist of a thermoplastic polymer component. Thermoplastics are notable for their good processing properties and can be processed to moldings in the softened state, by means of compression molding, extrusion, injection molding or other shaping techniques, for example.

The polymer composition of the invention may further comprise at least one additive, preferably selected from colorants, antioxidants, light stabilizers, UV absorbers, hindered amine light stabilizers (HALS), nickel quenchers, metal deactivators, reinforcing agents, fillers, antifogging agents, biocides, acid scavengers, antistats, further IR absorbers for long wave IR radiation such as kaolin, antiblocking agents such as SiO2, light scatters such as MgO or TiO2, and organic or inorganic reflectors (aluminum flakes, for example).

The total amount of optional further additives in the polymer composition is up to 15% by weight, based on the polymer melt from step (a.). The amount of these additives is preferably 0.5% to 15%, very preferably 0.5% to 10%, and more particularly 0.5% to 7.5%, by weight.

In the inventive production of the polymer composition, these optional additives are added either in one of steps (a.), (b.), (c.) and/or (d.) or as part of optional additional steps of the process. The addition of the additives may take place, for example, in step (a.), the providing of the polymer melt, or the polymers used for the polymer melt may already comprise the additives. The addition of the additives may also take place with the providing of the liquid composition in step (b.) that already comprises the additives. In the case of the mixing in step (c.) as well, further additives may be added to the mixture of the polymer melt and the liquid preparation. Further additives may also be added to the polymer composition during processing (d.) as well.

With the aid of the polymer compositions produced by the process of the invention, shaped articles can be produced. The shaped articles can be produced from the inventively produced polymer composition by methods known to the skilled person, such as extrusion, coextrusion, injection molding, and blow molding, for example.

The invention further provides for the use of the polymer compositions and of the shaped articles in heat management. Heat management comprises application in automobiles, architecture, home and office buildings, warehouses, stadiums, airports or other areas where the heat generated by incident thermal radiation is unwanted.

The polymer compositions or shaped articles are employed preferably in agriculture, more particularly as greenhouse films. Other preferred applications in agriculture are further agricultural films such as silage films, stretch wrap silage films, packaging films such as stretch covers and expanding covers, or heavy-goods bags.

The invention additionally provides films comprising the inventively prepared polymer composition, the films having from 1 to 7 layers, preferably from 1 to 4 layers, more particularly from 1 to 3 layers. These films preferably have a thickness of not more than 500 μm, preferably from 100 to 300 μm, very preferably from 150 to 250 μm, more particularly from 150 to 200 μm. The films generally have a thickness of at least 30 μm. The films can be produced for example by extrusion or coextrusion as described in Saechtling Kunststoff Taschenbuch, 28th edition, Karl Oberbach, 2001.

The shaped articles of the invention are preferably used also as glazing or roof material, as films in agriculture, more particularly greenhouse films, or as a constituent of windows.

It will be appreciated that the shaped articles of the invention can also be used to produce articles, more particularly components, which comprise one or more shaped articles. Such components may be employed in particular for the heat management of buildings.

The use of the polymer compositions or shaped articles of the invention, comprising nanoparticulate IR absorbers, enables effective shielding against the action of thermal radiation on the surface of—for example—buildings, vehicles or greenhouses. These materials enable heat management of interior spaces. Generally speaking, these materials ensure high transparency with respect to visible light in conjunction with effective screening of the thermal radiation, meaning that interior spaces remain light under insolation and do not heat up to such a great extent. An increased transparency has a directly positive effect, in the context of the use of the polymer compositions in greenhouse films, on an increased yield of the plants cultivated in the greenhouse.

The invention is illustrated by the examples, but the examples do not restrict the subject matter of the invention.

### EXAMPLES

### Example 1

### Production of Agricultural Films With Heat Management Function

Quantities figures are expressed in % by weight, based on the total amount of the masterbatch or of the film.

Since it is frequently difficult to meter small volumes of additives and to incorporate them homogeneously into a film, the additives are initially processed in the form of a masterbatch. This ensures homogeneous additivization of a polymer which is processed to a film, over the entire area of the film, and facilitates the operation.

The following additives were processed to a masterbatch by means of an extruder:
1.25% of nanoparticulate LaB₆, produced by in situ plasma synthesis,
15.0% of Uvinul® 5050H (HALS),
7.5% of Uvinul® 3008 (UV absorber),
2.5% of Irganox® B 225 (mixture of Irgafos® 168 and Irganox® 1010 from Ciba, antioxidant),
73.75% of LDPE (Low Density Polyethylene).

Nanoparticulate LaB₆ was added to the polymer melt (LDPE) via a liquid metering system, while the other ingredients were added in the form of powder or granules.

8% of the masterbatch was introduced together with 92% of LDPE granules via silos into the filling hopper of the extruder, which then processed the ingredients into a homogeneous plastics composition. The melted polymer emerged via a die and was shaped by appropriate air flows into a film bubble, which after cooling was folded to a film and rolled up.

These films were used in a greenhouse, and the temperature profile was compared with that in other greenhouse compartments in which standard films were used.

In winter, when using films of the invention, the maximum midday temperature was reduced by on average up to 5° C. At night, on the other hand, the temperature measured was only 1-2° C. lower.

In the summer months, in contrast, a temperature reduction of up to 10° C. at the midday time was detected.

Further films with the following compositions were produced in accordance with the process described above:

### Example 2

### Composition of the Film:

1.0% Uvinul® 5050H (HALS), 0.5% Uvinul® 3008 (UV absorber), 0.3% Irganox® 1010, 0.2% Irgafos® 168, 0.03% nanoparticulate LaB₆, 97.97% Lupolen® 1840 D (PE).

This film exhibits a reduction in the transmission of IR radiation in the wavelength range from 750 to 1500 nm of up to 50% by comparison with a film without nanoparticulate LaB₆.

This film likewise exhibits a reduction in the transmission of IR radiation in the wavelength range from 750 to 1500 nm of up to 50% by comparison with a film with agglomerated, non-nanoparticulate LaB₆ particles (particle size, for example, from 1 μm to 50 μm).

The further film compositions of examples 3 to 6 also show a comparable reduction in transmission as in example 2.

### Example 3

### Composition of the Film:

1.0% Uvinul® 5050H, 0.5% Uvinul® 3008, 0.3% Irganox® 1010, 0.2% Irgafos® 168, 0.03% nanoparticulate LaB₆, 97.97% Lupolen® 1840 D.

### Example 4

### Composition of the Film:

1.0% Uvinul® 5050H, 0.5% Uvinul® 3008, 0.3% Irganox® 1010, 0.2% Irgafos® 168, 0.0225% nanoparticulate LaB₆, 0.0075% Mark it® (antimony compound for laser marking), 97.97% Lupolen® 1840 D.

### Example 5

### Composition of the Film:

1.0% Uvinul® 5050H, 0.5% Uvinul® 3008, 0.3% Irganox® 1010, 0.2% Irgafos® 168, 0.03% nanoparticulate LaB₆, 0.5% magnesium oxide, 97.47% Lupolen® 1840 D.

### Example 6

### Composition of the Film:

1.0% Uvinul® 5050H, 0.5% Uvinul® 3008, 0.3% Irganox® 1010, 0.2% Irgafos® 168, 0.03% nanoparticulate LaB₆, 0.1% K 1010 (Ni titanate), 97.87% Lupolen® 1840 D.

1. A process for preparing a polymer composition, comprising:
(a) mixing a polymer melt with a preparation comprising a liquid carrier medium with nanoparticulate IR absorber dispersed therein, to give a mixture; and
(b) processing the mixture.

2. The process of claim 1, wherein the polymer melt comprises at least one thermoplastic polymer.

3. The process of claim 2, wherein the thermoplastic polymer comprises at least one selected from the group consisting of a polyolefin, a polyolefin copolymer, a polyvinyl alcohol, a polyvinyl ester, a polyvinylalkanol, a polyvinylketal, a polyamide, a polyimide, a polycarbonate, a polycarbonate blend, a polyester, a polyester blend, a poly(meth)acrylate, a poly(meth)acrylate-styrene copolymer blend, a poly(meth)acrylate-polyvinylidene difluoride blend, a polyurethane, a polystyrene, a styrene copolymer, a polyether, a polyetherketone, a polysulfone, and polyvinyl chloride.

4. The process of claim 1, wherein the preparation is produced by plasma synthesis of the nanoparticulate IR absorber.

5. The process of claim 1, wherein the preparation is produced by comminution of the IR absorber in the carrier medium.

6. The process of claim 5, wherein the comminution of the IR absorber in the carrier medium takes place by a milling operation.

7. The process of claim 5, wherein the IR absorber is in initially non-nanoparticulate form for the comminution.

8. The process of claim 1, wherein the nanoparticulate IR absorbers having a mass-average particle diameter of not more than 200 nm.

9. The process of claim 1, having a solids content of the preparation, based on a total weight of the preparation, of at least 1% by weight.

10. The process of claim 1, wherein an amount of nanoparticulate IR absorber, based on a total solids content of the preparation, is at least 1% by weight.

11. The process of claim 1, wherein the nanoparticulate IR absorber comprises at least one selected from the group consisting of a metal boride, ATO, ITO, and a nanoscale carbon black.

12. The process of claim 11, wherein the metal boride is present and is at least one hexaboride of formula MB₆, wherein M is a metal component.

13. The process of claim 1, wherein the liquid carrier medium comprises at least one selected from the group consisting of an ester of alkyl carboxylic acid, an ester of an arylcarboxylic acid, a hydrogenated ester of an arylcarboxylic acid with at least one alkanol, a monoalcohol, a polyhydric alcohol, an ether alcohol, a polyether polyol, an ether, saturated acyclic hydrocarbon, a saturated cyclic hydrocarbon, a mineral oil, a mineral oil derivative, a silicone oil, and an aprotically polar solvent.

14. The process of claim 1, wherein the liquid carrier medium comprises at least one selected from the group consisting of a polyolefin wax and a polyolefin comonomer wax.

15. The process claim 1, wherein the carrier medium comprises at least one selected from the group consisting of a ethylene glycol, glycerol, 1,3-propanediol, 1,4-butanediol, ethylene glycol monomethyl ether, ethylene glycol dimethyl ether, ethylene glycol diethyl ether, an acyclic ether, a cyclic ether, a polyether polyol, a low-boiling alcohol, and a hydrocarbon with a boiling point of less than 200° C.

16. The process of claim 1, wherein the preparation has at least one selected from the group consisting of a boiling temperature and a flash temperature above the processing temperature in the mixing (a).

17. The process of claim 1, wherein the preparation has a boiling temperature below the processing temperature in the mixing.

18. The process of claim 1, wherein the mixing (a) takes place with deposition of the carrier medium.

19. The process of claim 1, wherein the polymer melt further comprises, admixed, at least one additive selected from the group consisting of a colorant, an antioxidant, a light stabilizer, a UV absorber, a hindered amine light stabilizer, a nickel quencher, a metal deactivator, a reinforcing agent, a filler, an antifogging agent, a s biocide, an acid scavenger, an antistat, a further IR absorber for long wave IR radiation, an antiblocking agent, a light scatterer, an organic reflector, and an inorganic reflector.

20. The process of claim 1, wherein the mixing (a) of the polymer melt with the preparation (b.) takes place as part of an extrusion or kneading operation.

21. A polymer composition, prepared by the process of claim 1.

22. A heat management unit, comprising the composition of claim 20.

23. An agricultural unit, comprising the composition of claim 20.

24. A greenhouse film, comprising the composition of claim 20.

25. A silage film, a stretch-wrap silage film, a packaging film, or a heavy-materials bag, comprising the composition of claim 20.

26. A film, comprising the composition of claim 20, wherein the film comprises from 1 to 7 layers.

27. The film of claim 26, having a thickness of not more than 500 μm.
